(19) United States
(12) Patent Application Publication
(10) Pub. No.: US 2004/0255106 A1
(43) Pub. Date: Dec. 16, 2004

(54) Recovery of operating system configuration data by firmware of computer system

(76) Inventors: Michael A. Rothman, Gig Harbor, WA (US); Vincent J. Zimmer, Federal Way, WA (US)

Correspondence Address: Anthony H. Azure, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/459,216

(22) Filed: Jun. 10, 2003

(51) Int. Cl. G06F 9/00

(52) U.S. Cl. 713/1

(57) ABSTRACT

A method and system to recover operating system configuration data by firmware of a computer system during pre-boot. Recovery operating system (OS) configuration data corresponding to a last known good condition is stored. The current OS configuration data is validated. The OS is loaded according to the current OS configuration data if the current OS configuration data is valid. If the current OS configuration data is invalid, then the current OS configuration data is recovered with the recovery OS configuration data. In one embodiment, the recovery OS configuration data includes at least one of a bootable medium partitioning scheme and OS-specific data. In another embodiment, the firmware of the computer system operates in accordance with the Extensible Firmware Interface (EFI) framework standard to backup and recover OS configuration data.

### FIELD OF THE INVENTION

The field of invention relates generally to computer systems and, more specifically but not exclusively, relates to the recovery of operating system configuration data by firmware of a computer system.

### BACKGROUND INFORMATION

During a computer system startup, the computer system is self-tested and initialized through loading and execution of system firmware. Under personal computer (PC) architectures, this firmware is commonly referred to as the system's Basic Input/Output System (BIOS). In a typical PC architecture, the BIOS is generally defined as the firmware that runs between the processor reset and the first instruction of the Operating System (OS) loader. This is commonly referred to as the pre-boot phase and precedes the OS boot phase. At the start of a pre-boot, very little of the system beyond the processor and firmware is actually initialized. It is up to the code in the firmware to initialize the system to the point that an operating system loaded off of media, such as a hard disk, can take over.

Typically, at the end of the pre-boot phase, the BIOS searches for a Master Boot Record (MBR) residing on a magnetic disk to boot the OS. The MBR is placed at a predetermined location known to the BIOS. The MBR contains code to initiate the loading of the operating system. After the BIOS finds the MBR, it loads the MBR boot code into memory. This code is a small initial boot program that begins the OS boot process. The BIOS passes control to the operating system by directing the processor to begin executing the MBR boot code. The MBR boot code finds the active partition on the magnetic disk and executes the boot block of the active partition to load the OS stored in that partition.

Corruption of the MBR can result in serious problems for a computer system. The computer system may require some type of disaster recovery activity or may even become unbootable. The repair of such an OS boot failure usually involves action during the OS runtime and may result in the loss of data and OS configuration information. The corruption may occur due to accidental modification of the MBR or damage to the medium on which the boot record is stored. The corruption may also be due to a virus on the computer system. An MBR virus is a common type of virus that replaces the MBR with its own code. Since the MBR boot code executes every time a computer is started, this type of virus is extremely destructive.

### BRIEF DESCRIPTION OF THE DRAWINGS

The present invention is illustrated by way of example and not limitation in the accompanying figures.

FIG. 1 is a flowchart illustrating the logic and operations performed by a computer system under the EFI framework standard in accordance with one embodiment of the present invention.

FIGS. 2A and 2B are a flowchart illustrating the logic and operations performed by one embodiment of the invention for firmware to recover operating system configuration data.

FIG. 3 is a schematic diagram of a Master Boot Record scheme of a computer system according to one embodiment of the present invention.

FIG. 4 is a schematic diagram of a Globally Unique Identifier (GUID) Partition Table (GPT) scheme of a computer system according to one embodiment of the present invention.

FIG. 5 is a schematic diagram of a Host Protected Area (HPA) scheme of a computer system according to one embodiment of the present invention.

FIG. 6 is a schematic diagram illustrating a computer system that may be used to practice an embodiment of the present invention.

### DETAILED DESCRIPTION

Embodiments of a method to backup and recover operating system configuration data and computer apparatus for implementing the method are described herein. In the following description, numerous specific details are set forth, such as embodiments pertaining to the Extensible Firmware Interface (EFI) framework standard, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In accordance with aspects of the invention, a mechanism to backup and to recover operating system configuration data by firmware of a computer system is disclosed. Firmware components perform validity checks of OS configuration data of the current OS boot target. The current OS boot target refers to the OS to be booted by the computer system. OS configuration data includes OS bootable medium partitioning schemes, such as an MBR, and OS-specific data. OS-specific data includes data needed for booting and configuring the computer system and tailoring it to the current user. For example, OS-specific data for booting the Microsoft Windows OS is found in a registry database.

The firmware verifies the integrity of the operating system configuration data before the OS boot is actually executed. If the configuration data is corrupted, recovery of the data can be made during the pre-boot phase by restoring the corrupted data with recovery packet information. Performing the restoration during pre-boot allows for corruption to be repaired prior to commitment to the OS boot.

In accordance with one embodiment, the OS boot recovery may be implemented under an extensible firmware framework standard known as the Extensible Firmware Interface (EFI) (specifications and examples of which may be found at http://developer.intel.com/technology/efi). EFI is a public industry specification that describes an abstract programmatic interface between platform firmware and shrink-wrap operating systems or other custom application environments. The EFI standard include provisions for extending BIOS functionality beyond that provided by the BIOS code stored in a platform's BIOS device (e.g., flash memory). More particularly, EFI enables firmware, in the form of firmware modules and drivers, to be loaded from a variety of different resources, including primary and secondary flash devices, option ROMs, various persistent storage devices (e.g., hard disks, CD ROMs, etc.), and even over computer networks.

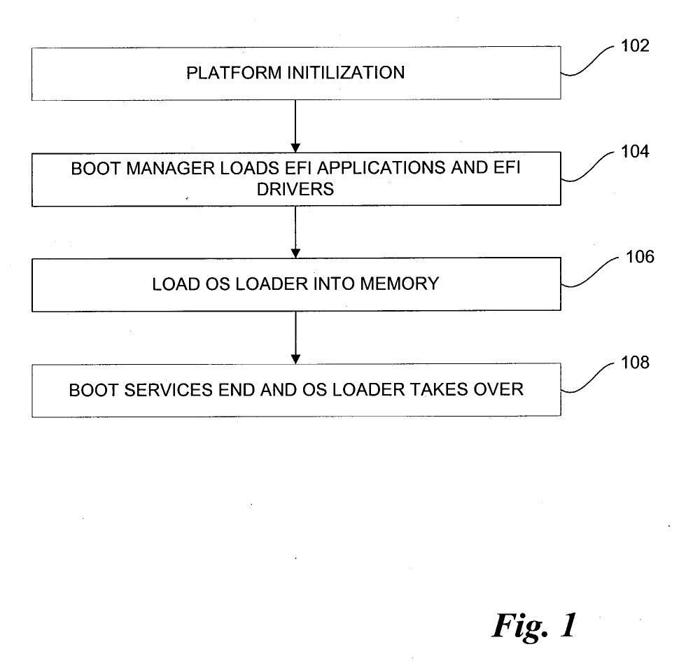

FIG. 1 shows an event sequence diagram used to illustrate operations performed by a computer system under one implementation of the EFI framework standard. In a block 102, power is added to a computer system and the platform initialization phase begins. This phase provides a standardized method of loading and invoking specific initial configuration routines for the processor, chipset, and motherboard. The initialization phase is responsible for initializing enough of the system to provide a stable base for the follow on phases. Initialization of the platforms core components, including the processor, chipset and main board (i.e., motherboard) is performed during this phase. This phase is also referred to as the “early initialization” phase. Typical operations performed during this phase include the POST (power-on self test) routine, and discovery of platform resources, such as memory.

Once the EFI firmware is initialized, it passes control to a Boot Manager, as depicted in a block 104. The Boot Manager is a firmware policy engine that loads EFI applications and EFI drivers into memory in a pre-defined order. EFI applications are modular code that may perform specific tasks outside of the OS environment. EFI drivers are modules of code that provide device support during the boot process or during OS runtime.

There are two types of EFI drivers: Boot Service Drivers and Runtime Service Drivers. Boot Service Drivers are not available after an OS Loader has taken control of the platform. Among others, these services include Memory Services, Protocol Handler Services, and Driver Support Services. In contrast to Boot Services, Runtime Services are available both during pre-boot and OS runtime operations. One of the Runtime Services that is employed by embodiments disclosed herein is the Variable Services. As described in further detail below, the Variable Services provide services to lookup, add, and remove environmental variables from both volatile and non-volatile storage.

In a block 106, the EFI OS Loader is loaded into memory. The OS Loader is the first piece of operating system code loaded by the firmware to initiate the OS boot process. The OS Loader is loaded at a fixed address and then executed. In one embodiment, a user is presented with a user interface generated by firmware to select the operating system to be booted. An EFI OS Loader can support multiple OS boot options that appear in the user interface. The user interface will also allow the selection of any EFI OS Loader from any partition on any boot medium that is supported by EFI boot services. An EFI OS Loader can also support legacy boot options such as booting from the A: drive or C: drive of the computer system.

Once the OS Loader is loaded, control of the computer system is transferred to the OS Loader, as shown in a block 108. If the OS Loader successfully loads its operating system, it can take control of the platform by using the Boot Service ExitBootServices. After successfully calling ExitBootServices, all boot services in the system are terminated. From this point the OS Loader is responsible for continued operation of the computer system. If the load of the OS fails, then the OS Loader returns an Exit call and control of the system is returned to the EFI firmware.

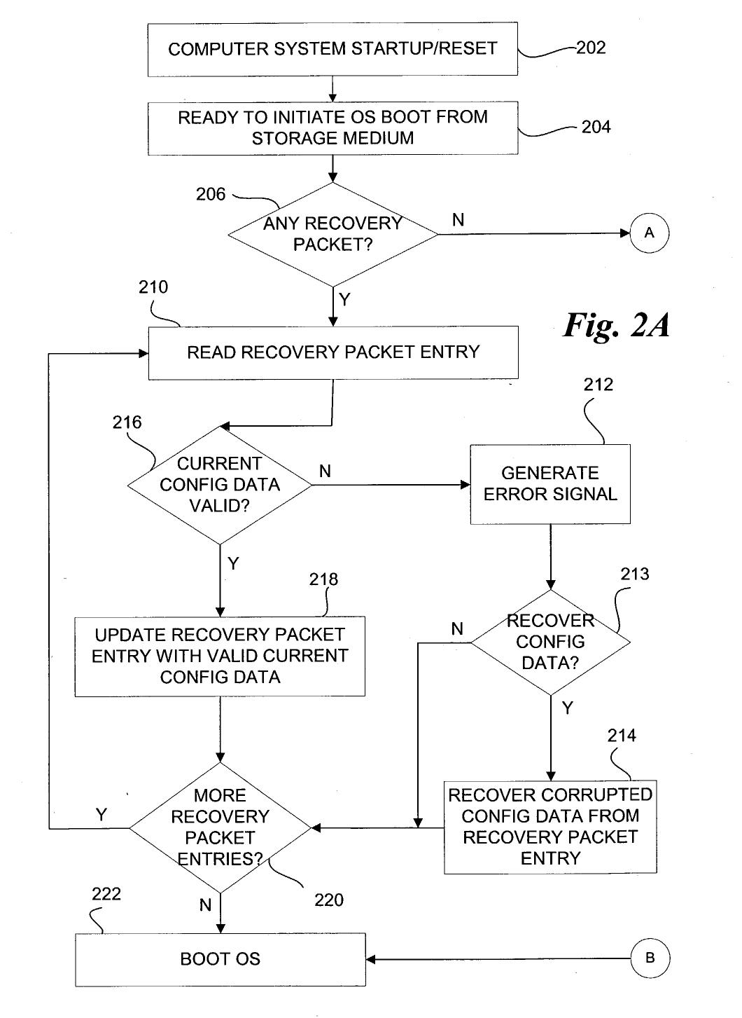

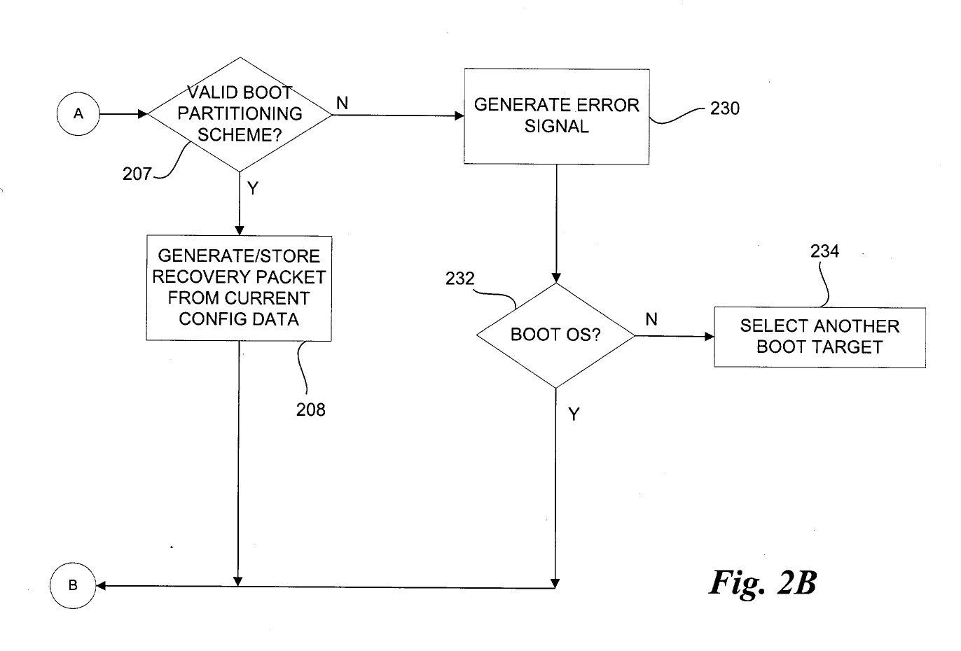

With reference to the flowchart of FIGS. 2A and 2B, one embodiment of the present invention operates in the following manner to backup and recovery OS configuration data by firmware of a computer system. The process begins in a block 202, which corresponds to a system startup event, i.e., a cold boot or a system reset.

In response to the startup event, the pre-boot phase of the computer system will begin loading and execution of system boot instructions stored in the computer system's BIOS firmware. In one embodiment, the computer system boot instructions will begin initializing the computer system by conducting a Power-On Self-Test (POST) routine, initializing system board functions, checking for any expansion boards that hold additional firmware, and loading such firmware if any is found.

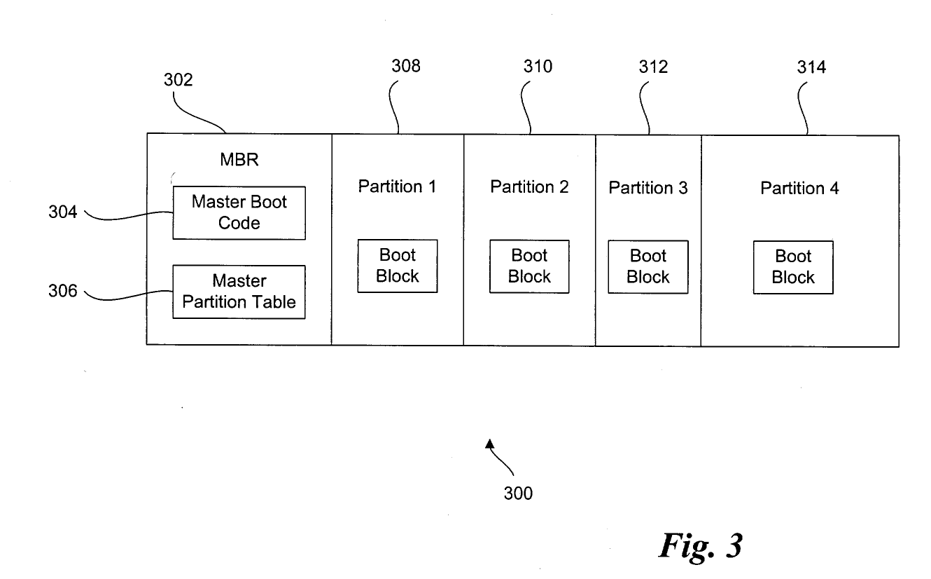

At a point in the pre-phase boot, the firmware is ready to initiate the OS boot from a storage medium, as depicted in a block 204. The OS that is ready to be booted is referred to as the current OS boot target for the computer system. In one embodiment, an operating system is booted from a storage medium, such as a hard disk, using a Master Boot Record (MBR). Referring to FIG. 3, a hard disk 300 is shown according to one embodiment of the present invention. In the first sector (sector 0) of the hard disk 300 is a MBR 302. The MBR 302 contains a Master Boot Code 304 and Master Partition Table 306. The MBR 302 includes information that identifies where an OS is located so it can be loaded into the computer system's memory and executed. The Master Partition Table 306 describes the partition(s) of the hard disk 300. Usually, a hard disk can have at most four true partitions, also referred to as primary partitions. Hard disk 300 contains partitions 308, 310, 312, and 314. It will be appreciated that in other embodiments, hard disk 300 could have less than four partitions. The Master Boot Code 304 contains a small initial boot program that the BIOS loads into memory and executes to start the OS boot. This program begins the OS boot process by examining the Master Partition Table 306 to determine which partition to use for booting (the active partition). After identifying the active partition, the code loads the first block of the active partition. This first block contains the partition boot block (also referred to as the partition boot record). Once the partition boot block is loaded into memory, it is executed to boot the operating system contained in the partition. For uniformity, usually every partition starts with a boot block. Even if a boot block does not contain a bootable operating system currently, reserving a boot block simplifies the installation of an OS in the partition at a later date. Referring to block 204 of FIG. 2A, in the embodiment described above, the Master Boot Code 304 has been loaded into memory and is ready to be executed.

In an alternative embodiment, the computer system operates in accordance with the EFI framework standard. In this case, in block 204, the OS Loader is loaded into memory and firmware is ready to initiate execution of the OS Loader and turn over control of the platform to the operating system.

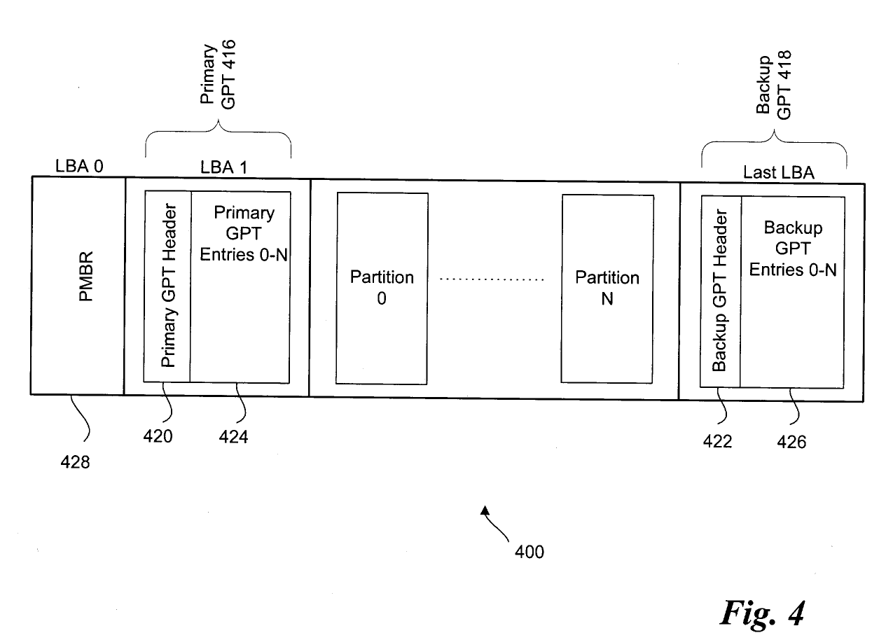

The EFI standard defines a disk partitioning scheme called the Globally Unique Identifier (GUID) Partition Table (GPT). GPT is a disk structure that allows more than four partition entries and provides robust description data for those partitions. FIG. 4 shows a hard disk 400 having a GPT scheme according to one embodiment of the present invention. A Primary GPT 416 is located in the second logical block address (LBA) and a Backup GPT 418 is located in the last LBA. Within each GPT are GPT Header structures: the Primary GPT Header 420 and the Backup GPT Header 422. Each GPT Header starts with a signature and a revision number. The signature identifies that the header is an EFI-compatible partition table header. The revision number specifies which version of the EFI specification defines the data bytes in the partition header. The Primary GPT 416 and the Backup GPT 418 also contain Primary GPT Entries 424 and Backup GPT Entries 426, respectively. The GPT Entries correspond to partitions 0-N of hard disk 400. The GPT Entries define the partitions that are contained in a range that is within the usable space declared by the GPT Headers.

To boot the OS, the OS Loader scans through the GPT Entries looking for a specific Partition Type GUID. The Partition Type GUID correlates to a partition that contains the boot target. Once the OS Loader finds the correct GUID, the OS boot target is loaded into memory and executed.

Hard disk 400 also contains a Protective Master Boot Record (PMBR) 428 in the first LBA. The Master Boot Code of PMBR 428 is not executed by EFI firmware, but is used to maintain compatibility with existing platforms that do not understand GPT partition structures. The PMBR 428 has the same format as a legacy MBR (discussed above).

Referring back to FIG. 2A, the logic proceeds to a decision block 206 to determine if there are any recovery packets for the operating system boot target. A recovery packet is a collection of OS configuration data regarding the last “known good” OS boot environment. The recovery packet has at least one entry describing aspects of the OS boot. The recovery packet can contain multiple entries for various OS configuration data. For example, a recovery packet can have a first entry for OS bootable medium partitioning scheme data and a second entry for OS-specific data. Partitioning scheme information includes MBR data and GPT data while OS-specific data includes registry information.

A registry is a central database for information needed for booting and configuring the OS of a computer system. An example of a registry is the Microsoft Windows Registry. When the computer system is turned off, most of the registry information is stored in files called hives. The integrity of the registry (and the hives) is critical for correct operating system functioning.

In one embodiment, the recovery packet contains a complete copy of a component of OS configuration data. For example, MBR and GPT structures are small and may be stored in a variety of places, including a non-volatile storage device. In another embodiment, the recovery packet includes certain structures selected according to a policy of the recovery packet creation algorithm. In another embodiment, the firmware conducts one or more validity algorithms to verify the integrity of the OS configuration data. In some cases, these validity algorithms do not need data from a recovery packet to perform a validation check. Such algorithms include, but are not limited to, signatures, certificates, Cyclic Redundancy Checks (CRC's), checksums, or the like.

In one embodiment, a recovery packet structure is defined as follows:

typedef struc {

| | | |
|---|---|---|
| EFI_SIGNATURE | Signature; | //Signature to validate against |
| | | the Data |
| EFI_DEVICE_PATH | FileLocation; | //File location |
| EFI_LBA | SectorStart; | //Starting sector of data |
| UINTN | SectorCount; | //Nmbr of sectors starting at |
| | | SectorStart |
| UINT8 | Data[1]; | //Last “known good” data |

} RECOVERY_PACKET;

The recovery packet can be stored in various places. In one embodiment, the recovery packet is stored in a storage device accessible to the computer system. Such a storage device includes, but is not limited to, a magnetic drive, an optical drive, a nonvolatile memory device, or the like. The storage device could also be accessible over a network. Such a network includes, but is not limited to, the Internet, a local area network (LAN), a wide area network (WAN), or the like.

In another embodiment, the recovery packet is stored in a Host Protected Area (HPA). An HPA is a reserved area for data storage outside the normal operating file system. An HPA specification has been published as “ANSI NCITS 346-2001 Protected Area Run Time Interface Extension Services” (American National Standards Institute (ANSI) and National Committee on Information Technology Standards (NCITS)).

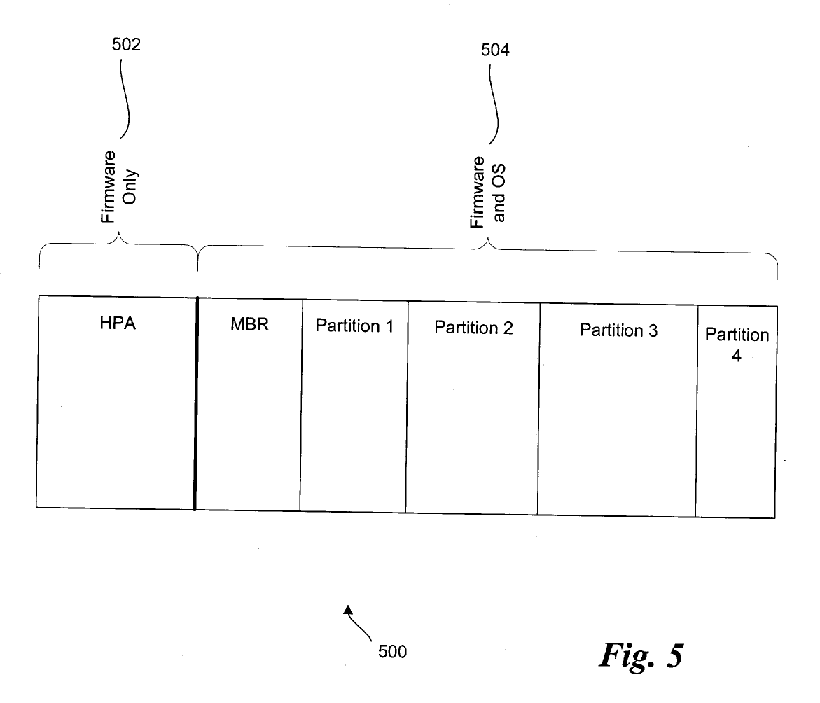

FIG. 5 shows one embodiment of an HPA scheme on a hard disk 500. An HPA 502 is at the first LBA of hard disk 500. HPA 502 is hidden from the OS and the file system, and is normally used by only certain applications. The HPA 502 offers a protected area from unintentional user corruption or virus attack. In contrast, area 504 is accessible to the firmware and the operating system. Area 504 includes the MBR and partitions 1-4. Area 504 is what the OS would perceive as the useable area of the hard disk 500.

A recovery packet could be stored by the firmware in an HPA allowing only the firmware knowledge of and access to the recovery packet. Since a hard drive has a large storage capacity, reserving a portion of the total capacity of the drive for the HPA has a negligible effect. For example, a typical recovery packet having a hive file or a registry file would comprise up to approximately 25 MB.

In another embodiment, the recovery packet could be stored in variable data of an EFI-compliant system. Variables are defined as key/value pairs that consist of identifying information plus attributes (the key) and arbitrary data (the value). Variables are intended for use as a means to store data that is passed between the EFI environment implemented in the platform and EFI OS Loaders and other applications that run in the EFI environment. Variables are available to the system under Variable Services of Runtime Services. Although the implementation of variable storage is not defined in the EFI specification, variables must be persistent in most cases. This implies that the EFI implementation on a platform must arrange it so that variables passed in for storage are retained and available for use each time the system boots, at least until they are explicitly deleted or overwritten. In one implementation of EFI, variables are maintained in a non-volatile storage called the Non-Volatile Random Access Memory (NVRAM).

Referring back to decision block 206 in FIG. 2A, if a recovery packet exists for the current OS boot target, then the logic proceeds to a block 210 to read the first entry of the recovery packet. Next, in a decision block 216, corruption detection is performed to determine if the current OS configuration data is valid. In some instances, such as OS specific data, corruption detection involves using the last “known good” structure of the recovery packet as a reference to verify the integrity of the current OS configuration data. In other cases, such as partitioning scheme data, corruption detection can occur without necessarily referring to a recovery packet.

In the case of a bootable medium partitioning scheme, the logic examines where the OS-related code loaded in memory wants to jump to in order to determine if that spot is a reasonable place to land. For an MBR scheme, the Master Boot Code should point to a boot record on the hard drive. In one embodiment, the firmware determines if the last bytes in LBA 0 (sector 0 of the disk) have a signature of 0x55AA. In another embodiment, the firmware determines if the active partition has an appropriate boot signature of 0x55AA at the last two bytes in the partition's boot block.

In one embodiment of an EFI-compliant system, the firmware examines the GPT to determine if the bootable medium partitioning scheme is valid, while in another EFI-compliant implementation, the EFI OS Loader performs the validity check. In one embodiment, the Primary GPT header 420 contains a signature, the EFI specification revision number, the header size, a header Cyclic Redundancy Check (CRC), the LBA for the Primary GPT, and a CRC for the Primary GPT Entries. To determine if the GPT is valid, validity algorithms verify at least one of the GPT signature, the GPT CRC, and the CRC of the Primary GPT Entries 424. A validation algorithm can also verify that a MyLBA field in the Primary GPT header 420 points to the LBA that contains the Primary GPT.

It will be appreciated that a CRC is a well-known method of checking the integrity of a block of data. In one implementation, a value is computed that depends on the hexadecimal sum of the number of 1's in the data block. This CRC value is associated with the block of data and can be used by other components to perform validation checks of the data block.

In one embodiment of an EFI framework standard, if the Primary GPT is corrupted, then the system Backup GPT is located and checked for validity. If the Backup GPT is valid then the Backup GPT is used to restore the Primary GPT. If both the Primary GPT and the Backup GPT are corrupted, then the recovery packet can be used to restore the Primary GPT to boot the operating system.

The validity of the registry of the current OS configuration data can also be checked by the logic of decision block 216. In one embodiment, the registry files must by an exact copy of their respective recovery packet entries to be valid. In another embodiment, portions of the registry files are examined to determine validity. In another embodiment, an operating system component, such as the OS Loader, can execute a validity algorithm on a registry file to ascertain whether corruption has occurred.

If the answer to decision block 216 is yes, then the logic proceeds to a block 218 to update the recovery packet with the current OS configuration data. The recovery packet should always maintain the last “known good” boot structure. In this way, if corruption is detected, the current boot structure can be restored to the most recent valid structure. This reduces the loss of data and configuration information that may occur by using an old OS rescue disk or other disaster recovery means containing outdated OS configuration data.

After updating the recovery packet in block 218, the logic proceeds to a decision block 220 to determine if the recovery packet contains any more entries. In one embodiment, the recovery packet may contain a plurality of entries to be used for validity checks. For example, the recovery packet may contain entries for the MBR data, the registry, and the hive files. The firmware will check the validity of all these entries, making recoveries as necessary, before turning control of the platform over to the operating system boot. If the answer to decision block 220 is yes, then the logic proceeds back to block 210 to read the next recovery packet entry. If the answer is no, then the logic proceeds to block 222 to boot the OS. To boot the OS, the firmware initiates the execution of the OS information that was loaded into memory in block 204. In a legacy system, the Master Boot Code is executed to begin the OS boot phase; in an EFI-compliant system, the OS Loader is executed. In an EFI system, once the OS Loader calls EndBootServices, the pre-boot phase ends.

Returning to decision block 216, if the current OS configuration data is not valid, then the logic proceeds to a block 212 to generate an error signal. In one embodiment, the error signal is used by a user interface in pre-boot to inform a user that an invalid boot target has been detected. In another embodiment, the error signal is used by a user interface in OS runtime to inform the user that a boot error occurred.

After generating an error signal, the logic continues to decision block 213 to determine if the corrupted OS configuration data should be recovered from the recovery packet entry. In one embodiment, a user interface is generated requesting a response from a user regarding restoring the OS configuration data. In another embodiment, firmware default settings indicate that the firmware should always recover invalid OS configuration data. In this embodiment, a user interface are available so that the settings for the recovery packet procedures can be changed as desired by the user.

If the answer to decision block 213 is no, then the logic proceeds to block 220 to determine if the recovery packet has more entries. In this case, the user (or default firmware settings) has chosen not to recover corrupted files, but to boot the OS using the “corrupted” OS configuration data. In some situations, a user may have made system modifications during a previous session and knows that these modifications will be considered by the logic as corruption. Decision block 213 offers the opportunity to supersede erroneous corruption detection.

If the answer to decision block 213 is yes, then the logic continues to a block 214 to recover the corrupted OS configuration data from the recovery packet entry. In one embodiment, the recovery packet overwrites the existing OS configuration data files and/or structures with the corresponding recovery packet entry. After the recovery is completed, then the logic proceeds to decision block 220 to determine if the recovery packet has any more entries.

Returning to decision block 206, if the answer to decision block 206 is no, then the logic proceeds to a block 207, shown in FIG. 2B, to determine if the boot able medium partitioning scheme is valid. Generally, validation checks involve using a recovery packet as a reference. However, a standards-based structure, such as a boot partitioning scheme, can be validated without using a corresponding recovery packet. Thus, when there is no corresponding recovery packet for the current boot target, the firmware can still perform a validation check of the boot partitioning scheme, as depicted in block 207. In one embodiment, the validation of a boot partitioning scheme, such as a MBR or a GPT, is conducted using a validation algorithm as discussed above in conjunction with block 216.

If the answer to decision block 207 is yes, the firmware generates and stores a recovery packet from the current OS configuration data, as illustrated in a block 208. In one embodiment, this would entail copying and storing at least one of the MBR, the GPT, and the registry.

Continuing with the flowchart of FIG. 2B, after generating and storing a recovery packet in block 208, the logic proceeds to block 222 to boot the operating system from the current OS boot target.

If the answer to decision block 207, then the logic proceeds to a block 230, in FIG. 2B, to generate an error signal. In one embodiment, the error signal depicted in block 230 is similar to the error signal shown in block 212. In another embodiment, the error signal is used to generate an error message for the user that the current boot target is corrupted.

The logic proceeds to a decision block 232 to determine if the OS should be booted from the current boot target. In one embodiment, the user is presented with a user interface asking the user if the computer system should be booted from the current boot target. In another embodiment, default settings of the computer system indicate that the system will not be booted from the current boot target if a corruption is detected.

If the answer to decision block 232 is yes, then the logic proceeds to block 222 to boot the OS. If the answer to decision block 232 is no, then the logic proceeds to a block 234 to select another boot target. In one embodiment, the user is presented with a user interface to select another boot target. In another embodiment, the firmware uses default settings to boot from an alternate boot target.

It will be appreciated that in one embodiment, the computer system can run both legacy and EFI aware operating systems. A platform can comply with the EFI specification and also support legacy OS binaries that have no knowledge of the EFI specification. The EFI specification does not prevent a platform from supporting both EFI and legacy BIOS infrastructures.

In some cases, a platform may have more than one recovery packet if the system has more than one bootable operating system image. For example, a hard disk may be partitioned to contain a Microsoft Windows partition and a Unix partition. In such a scheme, the computer system can generate and store a recovery packet for each operating system. The recovery packets will be used to check the OS configuration data validity and to perform recoveries upon subsequent boots of their respective operating systems.

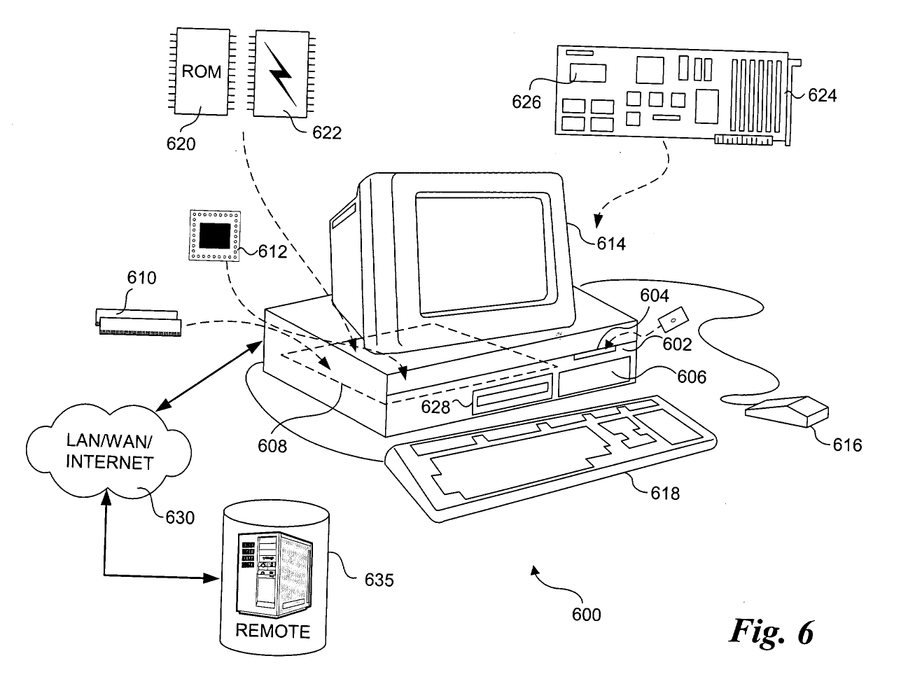

FIG. 6 illustrates an embodiment of an exemplary computer system 600 to practice an embodiment of the invention described above. Computer system 600 is generally illustrative of various types of computer devices, including personal computers, laptop computers, workstations, servers, etc; for simplicity, only the basic components of the computer system are discussed herein. Computer system 600 includes a processor chassis 602 in which various hardware components are housed, including a floppy disk drive 604, a hard disk 606, a power supply (not shown), and a motherboard 608 populated with appropriate integrated circuits including system memory 610 coupled to one or more processors 612. System memory 610 may include, but is not limited to, Dynamic Random Access Memory (DRAM), Static Random Access Memory (SRAM), Synchronized Dynamic Random Access Memory (SDRAM), Rambus Dynamic Random Access Memory (RDRAM), or the like. Processor 612 may be a conventional microprocessor including, but not limited to, an Intel Corporation x86, Pentium, or Itanium family microprocessor, a Motorola family microprocessor, or the like. Hard disk 606 may comprise a single unit, or multiple units, and may optionally reside outside of computer system 600. The system also includes a boot firmware device on which firmware is stored, which may typically comprise non-volatile memory such as a ROM device 620 or a flash device 622. Other non-volatile memory devices include, but are not limited to, an Erasable Programmable Read Only Memory (EPROM), an Electronically Erasable Programmable Read Only Memory (EEPROM), or the like. The motherboard may include other firmware devices as well (not shown). In general, the system's processors will comprise 32- or 64-bit architectures, and the system memory will include physical addressing schemes appropriate to the processor(s), and may be accessed via corresponding address and data buses to which the processor(s) and the memory are connected.

A monitor 614 is included for displaying graphics and text generated by firmware, software programs and program modules that are run by computer system 600, such as system information presented during system boot. A mouse 616 (or other pointing device) may be connected to a serial port, USB port, or other like bus port communicatively coupled to processor(s) 612. A keyboard 618 is communicatively coupled to motherboard 608 in a similar manner as mouse 616 for user entry of text and commands. In one embodiment, computer system 600 also includes a network interface card NIC or built-in NIC interface (not shown) for connecting computer system 600 to a computer network 630, such as a local area network (LAN), wide area network (WAN), or the Internet. In one embodiment network 630 is further coupled to a remote computer 635, such that computer system 600 and remote computer 635 can communicate. In one embodiment, a portion of the system's firmware is loaded during system boot from remote computer 635.

The illustrated embodiment further includes an optional add-in card 624 that is coupled to an expansion slot of motherboard 608. In one embodiment, add-in card 624 includes an Option ROM 626 on which firmware is stored. Computer system 600 may also optionally include a compact disk-read only memory (“CD-ROM”) drive 628 into which a CD-ROM disk may be inserted so that executable files, such as an operating system, and data on the disk can be read or transferred into system RAM 610 and/or hard disk 606. Other mass memory storage devices may be included in computer system 600.

In another embodiment, computer system 600 is a handheld or palmtop computer, which are sometimes referred to as personal digital assistants (PDAs). Handheld computers may not include a hard disk or other mass storage, and the executable programs are loaded from a corded or wireless network connection into memory 610 for execution by processor 612. A typical computer system 600 will usually include at least a processor 612, memory 610, and a bus (not shown) coupling the memory 610 to the processor 612.

It will be appreciated that in one embodiment, computer system 600 is controlled by operating system software that includes a file management system, such as a disk operating system, which is part of the operating system software. For example, one embodiment of the present invention utilizes Microsoft Windows as the operating system for computer system 600. In another embodiment, other operating systems such as, for example, but not limited to the Apple Macintosh operating system, the Linux operating system, the Microsoft Windows CE operating system, the Unix operating system, the 3Com Palm operating system, or the like may also be use in accordance with the teachings of the present invention.

Thus, embodiments of this invention may be used as or to support a firmware and software code executed upon some form of processing core (such as processor 612) or otherwise implemented or realized upon or within a machine-readable medium. A machine-readable medium includes any mechanism that provides (i.e., stores and/or transmits) information in a form readable by a machine (e.g., a computer, network device, personal digital assistant, manufacturing tool, any device with a set of one or more processors, etc.). For example, a machine-readable medium can includes, but is not limited to, a read only memory (ROM), a random access memory (RAM), a magnetic disk storage media, an optical storage media, a flash memory device, or the like. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
storing recovery operating system (OS) configuration data corresponding to a last known good condition;
verifying the validity of current OS configuration data; and
loading an operating system using the current OS configuration data if the current OS configuration data are verified to be valid; otherwise
recovering the current OS configuration data with the recovery OS configuration data if the current OS configuration data are determined to be invalid.

2. The method of claim 1, wherein data relating to the recovery OS configuration data are stored via a recovery packet, and wherein verifying the validity of the current OS configuration data comprises extracting authentication data from the recovery packet and employing the authentication data to validate the current OS configuration data.

3. The method of claim 2, wherein employing the authentication data to validate the current OS configuration data comprises verifying at least a portion of the current OS configuration data using information from the recovery packet.

4. The method of claim 2, wherein employing the authentication data to validate the current OS configuration data comprises performing a validity algorithm on the current OS configuration data.

5. The method of claim 2, wherein the recovery packet comprises at least one of a bootable medium partitioning scheme and an OS-specific data.

6. The method of claim 1, further comprising generating an error signal if the current OS configuration data is determined to be invalid.

7. The method of claim 2, wherein recovering the current OS configuration data comprises modifying the current OS configuration data with information from the recovery packet.

8. The method of claim 7, wherein modifying the current OS configuration data comprises overwriting a bootable medium partitioning scheme of the current OS configuration data with a bootable medium partitioning scheme of the recovery packet.

9. The method of claim 1, further comprising generating new recovery OS configuration data from the current OS configuration data if the current OS configuration data are verified to be valid.

10. The method of claim 1, wherein the recovery OS configuration data are stored in a manner by which the data are inaccessible by the operating system.

11. The method of claim 10, wherein the recovery OS configuration data are stored in a Host Protected Area (HPA) of a storage device.

12. The method of claim 1, wherein the recovery OS configuration data are stored in a non-volatile memory device.

13. The method of claim 1, further comprising generating recovery OS configuration data from the current OS configuration data if no recovery OS configuration data exist and a bootable medium partitioning scheme of the current OS configuration data is determined to be valid.

14. The method of claim 1, wherein the method is performed by firmware executed by a computer system during a pre-boot phase of the computer system.

15. An article of manufacture comprising:
a machine-readable medium on which a plurality of instructions are stored, which when executed perform operations comprising:
reading a recovery packet corresponding to an operating system (OS) boot target, the recovery packet including last known good OS configuration data of the operating system;
verifying the validity of current OS configuration data; and
loading the operating system using the current OS configuration data if it is verified to be valid; otherwise
recovering OS configuration data from the recovery packet if the current OS configuration data is determined to be invalid.

16. The article of manufacture of claim 15, wherein recovering the OS configuration data comprises overwriting at least a portion of the current OS configuration data with data from the recovery packet.

17. The article of manufacture of claim 15, wherein verifying the validity of the current OS configuration data comprises verifying at least a portion of the current OS configuration data using information from the recovery packet.

18. The article of manufacture of claim 17, wherein the at least of a portion of the current OS configuration data comprises a bootable medium partitioning scheme.

19. The article of manufacture of claim 17, wherein the at least of a portion of the current OS configuration data comprises OS-specific data.

20. The article of manufacture of claim 15, wherein verifying the validity of the current OS configuration data comprises performing a validity algorithm on at least a portion of the current OS configuration data.

21. The article of manufacture of claim 20, wherein the validity algorithm is employed to validate a signature in a bootable medium partitioning scheme of the current OS configuration data.

22. The article of manufacture of claim 15, wherein the recovery packet is stored at a place not accessible by the operating system.

23. The article of manufacture of claim 22, wherein the recovery packet is stored in a Host Protected Area (HPA) of a storage device.

24. The article of manufacture of claim 15, wherein the recovery packet is stored as variable data in a non-volatile storage device in accordance with the Extensible Firmware Interface (EFI) framework standard.

25. The article of manufacture of claim 15, wherein the recovery packet is stored in a storage device accessible to the computer system via a network.

26. The article of manufacture of claim 15, wherein the plurality of instructions comprise firmware configured to operate in accordance with the Extensible Firmware Interface (EFI) framework standard.

27. A computer system, comprising:
a processor; and
at least one flash device operatively coupled to the processor on which firmware instructions are stored, which when executed by the processor perform operations comprising:
storing a recovery packet for the computer system, the recovery packet including last known good operating system (OS) configuration data of a current OS boot target of the computer system;
verifying the validity of current OS configuration data of the computer system; and
loading the operating system using the current OS configuration data if verified to be valid; otherwise
recovering the current OS configuration data with OS configuration data from the recovery packet if the current OS configuration data is determined to be invalid.

28. The computer system of claim 27, further comprising a storage device operatively coupled to the processor and having a Host Protected Area (HPA) in which the recovery packet is stored.

29. The computer system of claim 27, wherein the recovery packet is stored in the at least one flash device.

30. The computer system of claim 27, wherein the firmware instructions are configured to operate in accordance with the Extensible Firmware Interface (EFI) framework standard.
